(19) United States
(12) Patent Application Publication
(10) Pub. No.: US 2019/0041586 A1
(43) Pub. Date: Feb. 7, 2019

(54) OPTICAL CONNECTOR-EQUIPPED FIBER AND OPTICAL COUPLING STRUCTURE

(71) Applicant: SUMITOMO ELECTRIC INDUSTRIES, LTD., Osaka-shi, Osaka (JP)

(72) Inventors: Takako HOSOKAWA, Yokohama-shi, Kanagawa (JP); Sho YAKABE, Yokohama-shi, Kanagawa (JP); Osamu SHIMAKAWA, Yokohama-shi, Kanagawa (JP); Tomomi SANO, Yokohama-shi, Kanagawa (JP)

(73) Assignee: SUMITOMO ELECTRIC INDUSTRIES, LTD., Osaka-shi, Osaka (JP)

(21) Appl. No.: 16/073,847

(22) PCT Filed: Nov. 11, 2016
(86) PCT No.: PCT/JP2016/083591

§ 371 Date: Jul. 30, 2018

(30) Foreign Application Priority Data
Mar. 1, 2016 (JP) 2016-038573

(51) Int. Cl. G02B 6/38; G02B 6/02

(52) U.S. Cl. CPC G02B 6/3818; G02B 6/02004; G02B 6/3882; G02B 6/3834

(57) ABSTRACT

An optical connector-equipped fiber (2A, 2B) has optical fibers (10a), a ferrule (11), guide holes, and a structure for regulating a space between end faces (11a) of the ferrules (11). A relative position between the end faces (11a) is fixed by guide pins being inserted into the guide holes. Normals with respect to leading end faces of the optical fibers are inclined with respect to optical axes of the optical fibers. MFDs of the optical fibers are gradually expanded toward the leading end faces and are maximized at the leading end faces. The optical axes of the pair of facing optical fibers that are optically coupled are not present on the same optical axis.

### TECHNICAL FIELD

The present invention relates to an optical connector-equipped fiber and an optical coupling structure.

### BACKGROUND ART

A ferrule used for an optical connector connecting a plurality of optical fibers is disclosed in Patent Literature 1. This ferrule has a plurality of holes for holding the plurality of optical fibers, an inner surface that is in contact with leading ends of the plurality of optical fibers and positions the leading ends, a recess whose end face is provided in front of the inner surface, and lenses that are integrally formed in the recess.

### CITATION LIST

### Patent Literature

[Patent Literature 1] United States Patent Publication No. 2012/0093462

### SUMMARY OF INVENTION

### Technical Problem

As a system for connector connection of optical fibers, a physical contact (PC) system is generally known. FIGS. 9(a) and 9(b) are side sectional views illustrating an example of an optical coupling structure of a PC system. FIG. 9(a) illustrates a pre-connection state, and FIG. 9(b) illustrates a connected state. A ferrule 100 has a columnar external appearance, and has a hole 102 for holding an optical fiber 120 on the central axis thereof. The optical fiber 120 is inserted into the hole 102, and a leading end thereof slightly protrudes outward from a leading end face 104 of the ferrule 100. In this PC system, the leading end of the optical fiber 120 is pressed by physical contact with a leading end of a connecting counterpart connector (FIG. 9(b)), and thereby the optical fibers 120 are efficiently optically coupled. This system is mainly used when single-core optical fibers are connected.

However, this system has the following problems. That is, if optical fibers are connected in a state in which foreign materials adhere to end faces of ferrules, the foreign materials are closely adhered to the end faces of the ferrules due to a pressing force. A contact type cleaner needs to be used to remove the closely adhered foreign materials. There is a need to frequently perform cleaning to prevent the close adhesion of foreign materials. In addition, when a plurality of optical fibers are simultaneously connected, a predetermined pressing force is required for each optical fiber. For this reason, as the number of optical fibers increases, a greater force is required for the connection.

With regard to the above problems, for example, as described in Patent Literature 1, a space is provided between leading end faces of optical fibers that are connected to each other, and a lens is disposed in the space portion. FIG. 10 is a side sectional view schematically illustrating an example of such an optical coupling structure. A ferrule 200 of FIG. 10 has a hole 202 for holding an optical fiber 120, an inner surface 204 that is in contact with a leading end of the optical fiber 120 and positions the leading end, and a lens 208 that is provided on an end face 205 in front of the inner surface 204. However, in this structure, a position of the optical fiber 120 needs to be accurately aligned. When the lens 208 is a component independent of the ferrule 200 and is joined with the ferrule 200, a position of the lens 208 also needs to be accurately aligned in addition to the optical fiber 120. Therefore, the number of components requiring alignment work is increased, and a positional error (a tolerance) allowed for each component becomes strict. Hence, an aligning process is complicated or takes longer time.

An aspect of the present invention was made in view of the above problems, and is directed to providing an optical connector-equipped fiber and an optical coupling structure in which an end face of a ferrule is easily cleaned, a great force is not required for connection even when a plurality of optical fibers are simultaneously connected, and alignment work is easily performed.

### Solution to Problem

An optical connector-equipped fiber according to an embodiment of the present invention has optical fibers and a ferrule. The ferrule includes optical fiber holding holes that hold the optical fibers, a ferrule end face that faces a counterpart optical connector, and guide holes into which guide pins are inserted. Leading end faces of the optical fibers are exposed on the ferrule end face. Normal directions of the ferrule end face and the leading end faces of the optical fibers are approximately parallel and are inclined with respect to directions of optical axes of the optical fibers. A spacer is provided as another member on the ferrule end face, and has an opening allowing passage of optical paths that extend from the leading end faces of the optical fibers. Mode field diameters (MFDs) of the optical fibers are gradually expanded toward the leading end faces and are maximized at the leading end faces.

In addition, an optical coupling structure according to an embodiment of the present invention includes first and second optical connector-equipped fibers that are connected to each other. Each of the first and second optical connector-equipped fibers has optical fibers and a ferrule. The ferrule includes optical fiber holding holes that hold the optical fibers, a ferrule end face that faces a counterpart optical connector, and guide holes into which guide pins are inserted. Leading end faces of the optical fibers are exposed on the ferrule end face. Normal directions of the ferrule end face and the leading end faces of the optical fibers are approximately parallel and are inclined with respect to directions of optical axes of the optical fibers. MFDs of the optical fibers are gradually expanded toward the leading end faces and are maximized at the leading end faces. The first and second optical connector-equipped fibers face each other in a vertically inverted state in which the ferrule end faces thereof are approximately parallel to each other, and a spacer is provided as another member between the ferrule end faces thereof. The spacer has an opening allowing passage of optical paths that extend from the leading end faces of the optical fibers. The first and second optical connector-equipped fibers have relative positions fixed by the guide pins.

### Advantageous Effects of Invention

According to an aspect of the present invention, an optical connector-equipped fiber and an optical coupling structure in which an end face of a ferrule is easily cleaned, a great force is not required for connection even when a plurality of optical fibers are simultaneously connected, and alignment work is facilitated can be provided.

### BRIEF DESCRIPTION OF DRAWINGS

FIG. 1 is a side sectional view illustrating a configuration of an optical coupling structure according to an embodiment of the present invention.

FIG. 2 is a sectional view of the optical coupling structure taken along line II-II of FIG. 1.

FIG. 3 is an enlarged sectional view illustrating the optical coupling structure around a leading end face of an optical fiber.

FIGS. 4(a) and 4(b) are front views illustrating a leading end face of an optical connector-equipped fiber and a ferrule end face.

FIG. 5 is an enlarged sectional view illustrating the vicinity of the leading end face of the optical fiber of the optical coupling structure according to the embodiment of the present invention.

FIG. 6 is an exploded perspective view of a spacer and a ferrule of the optical connector-equipped fiber.

FIG. 7 is a side sectional view illustrating configurations of the ferrule and the optical fiber of the optical connector-equipped fiber according to an embodiment of the present invention.

FIG. 8 is a side sectional view illustrating the configurations of the ferrule and the optical fiber of the optical connector-equipped fiber according to the embodiment of the present invention.

FIGS. 9(a) and 9(b) are side sectional views illustrating a structure of a ferrule of a PC system, wherein FIG. 9(a) illustrates a pre-connection state, and FIG. 9(b) illustrates a connected state.

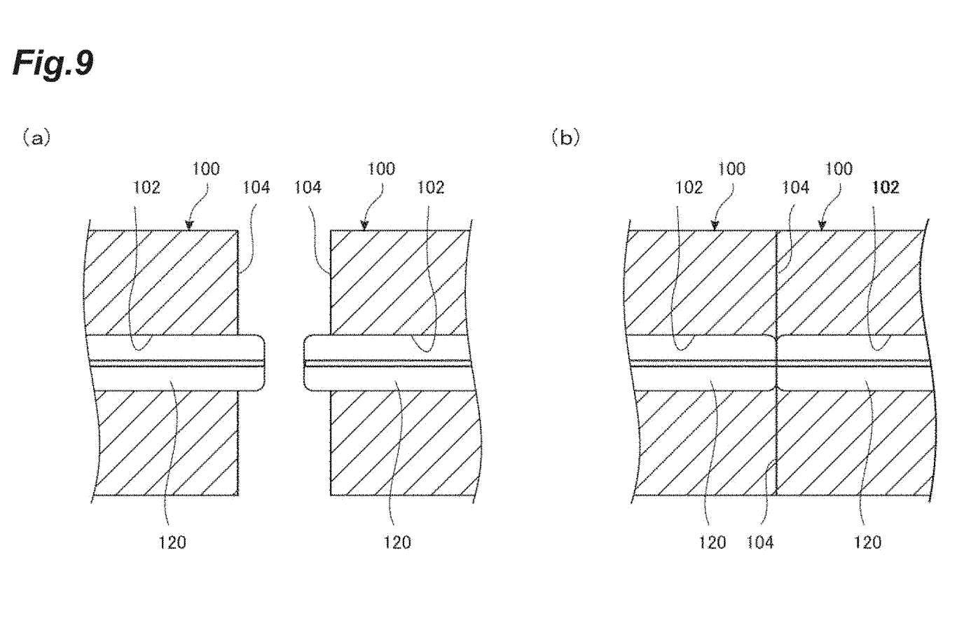

FIG. 10 is a side sectional view schematically illustrating a structural example of a ferrule in which a space is provided between leading end faces of optical fibers that are connected to each other and a lens is arranged in the space portion.

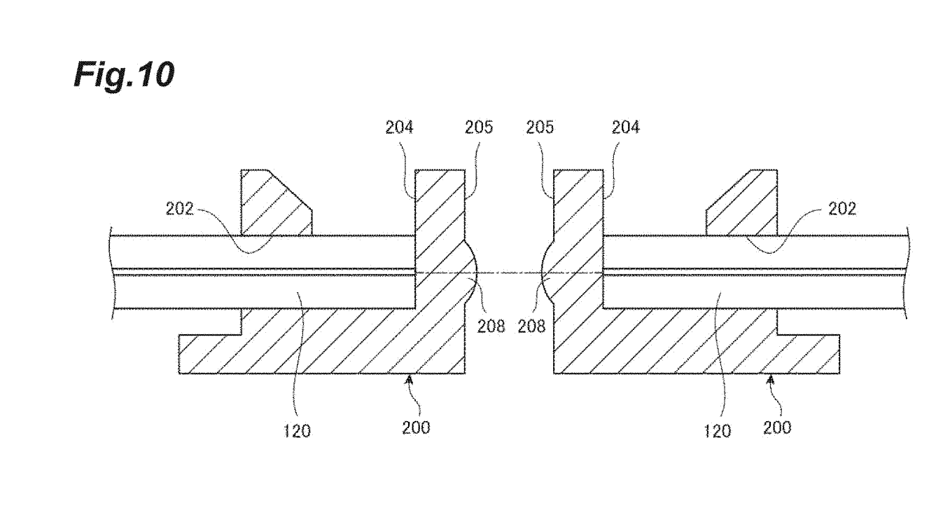

### DESCRIPTION OF EMBODIMENTS

### Description of an Embodiment of the Present Invention

First, content of an embodiment of the present invention will be described. An optical connector-equipped fiber according to an embodiment of the present invention has optical fibers and a ferrule. The ferrule includes optical fiber holding holes that hold the optical fibers, a ferrule end face that faces a counterpart optical connector, and guide holes into which guide pins are inserted. Leading end faces of the optical fibers are exposed on the ferrule end face. Normal directions of the ferrule end face and the leading end faces of the optical fibers are approximately parallel and are inclined with respect to directions of optical axes of the optical fibers. A spacer is provided as another member on the ferrule end face and has an opening allowing passage of optical paths that extend from the leading end faces of the optical fibers. MFDs of the optical fibers are gradually expanded toward the leading end faces and are maximized at the leading end faces.

An optical coupling structure according to an embodiment of the present invention includes first and second optical connector-equipped fibers connected to each other. Each of the first and second optical connector-equipped fibers has optical fibers and a ferrule. The ferrule includes optical fiber holding holes that hold the optical fibers, a ferrule end face that faces the counterpart optical connector, and guide holes into which guide pins are inserted. Leading end faces of the optical fibers are exposed on the ferrule end face. Normal directions of the ferrule end face and the leading end faces of the optical fibers are approximately parallel and are inclined with respect to directions of optical axes of the optical fibers. ATMs of the optical fibers are gradually expanded toward the leading end faces and are maximized at the leading end faces. The first and second optical connector-equipped fibers face each other in a vertically inverted state in which the ferrule end faces thereof are approximately parallel to each other, and a spacer is provided between the ferrule end faces thereof as another member. The spacer has an opening allowing passage of optical paths that extend from the leading end faces of the optical fibers. The first and second optical connector-equipped fibers have relative positions fixed by the guide pins.

In the optical connector-equipped fiber, the spacer is provided as the other member for regulating a space from the counterpart optical connector for the ferrule. Likewise, in the optical coupling structure, the spacer is provided as the other member for regulating a space between the ferrule of the first optical connector-equipped fiber and the ferrule of the second optical connector-equipped fiber. Thereby, a predetermined space can be easily provided between the ferrule end face and the counterpart optical connector (or between the ferrule end faces of the first and second optical connector-equipped fibers). Therefore, a noncontact optical coupling structure can be realized so that cleaning of the ferrule end face can be eased (or made unnecessary). Unlike a PC system, a plurality of optical fibers can be connected at the same time without requiring a great force for connection. Further, since a lens is not interposed between the optical fibers, the number of optical members present on the optical path can be reduced, and an optical coupling loss can be suppressed.

In the optical connector-equipped fiber, the normal directions of the ferrule end face and the leading end faces of the optical fibers are inclined with respect to the directions of the optical axes of the optical fibers. Thereby, return light reflected on the leading end faces of the optical fibers can be reduced. In the optical connector-equipped fiber, since the spacer and the ferrule are different members, the inclined ferrule end face and the inclined leading end faces of the optical fibers can be easily formed by polishing or the like.

In the optical connector-equipped fiber, the guide holes, into which the guide pins are inserted in a direction intersecting the end faces, are formed in the ferrule end face, and central positions of the leading end faces of the optical fibers on the ferrule end face are shifted with respect to a straight line passing through the centers of the guide holes. In the optical connector-equipped fiber, since the normal directions of the leading end faces of the optical fibers are inclined with respect to the directions of the optical axes of the optical fibers, optical paths extending from the leading end faces of the optical fibers are inclined with respect to the optical axes of the optical fibers due to refraction on the leading end faces. Even in this configuration, the central positions of the leading end faces of the optical fibers are shifted with respect to the straight line passing through the centers of the guide holes, and thereby the optical connector-equipped fiber and the counterpart optical connector-equipped fiber having the same configuration can be adequately optically coupled in consideration of refraction of the optical paths on the end face.

The ferrule of the optical connector-equipped fiber may have a plurality of optical fiber holding holes. Further, a method of arranging the optical fiber holding holes may be a plurality of rows in a second direction that intersects a connecting direction (a first direction) and is parallel to the straight line connecting the centers of the guide holes, and a plurality of stages in a third direction that intersects the first direction as well as the second direction. According to the ferrule of the optical connector-equipped fiber, even in the case of this multifiber ferrule, connection of the counterpart optical connector can be performed without requiring a great force.

In the optical connector-equipped fiber, the guide holes, into which the guide pins are inserted in the direction intersecting the end faces, are formed in the ferrule end face, and the spacer may further include through-holes through which the guide pins pass. Thereby, the spacer can be stably held by the guide pins.

In the optical coupling structure, a space between the ferrules in the first direction may be equal to or more than 20 μm and equal to or less than 100 μm. In this way, the space is narrow, and thereby light emitted from the leading end faces of the optical fibers can reach the leading end faces of the optical fibers of the counterpart optical connector before a diameter of the beam of light expands, and hence a drop in optical coupling efficiency can be suppressed.

In the optical connector-equipped fiber according to the embodiment of the present invention, the optical fibers in which the MFDs are gradually increased toward the leading end faces and are maximized on the leading end faces may be provided. This optical fiber has a smaller numeral aperture than that of a typical optical fiber. Therefore, expansion of the emitted light can be suppressed, and optical coupling efficiency of the optical fibers can be improved without a lens being interposed between the optical fibers.

In the optical connector-equipped fiber according to the embodiment of the present invention, a diameter of the fiber holding hole at the end face portion of the ferrule may be smaller than that of the hole at an inner portion of the ferrule. Thereby, when the optical fibers, the leading ends of which have a reduced outer diameter, are inserted into the ferrule, the optical axes of the optical fibers can be matched with the centers of the fiber holding holes without performing alignment work.

### Details of Embodiments of the Present Invention

An optical connector-equipped fiber and an optical coupling structure according to embodiments of the present invention will be described below with reference to the drawings. The present invention is not limited to these examples and is defined by the claims, and is intended to include all the modifications and alternations within meanings and a scope equivalent to the claims. In the following description, the same elements as in the description of the drawings are given the same reference signs, and duplicate descriptions thereof will be omitted.

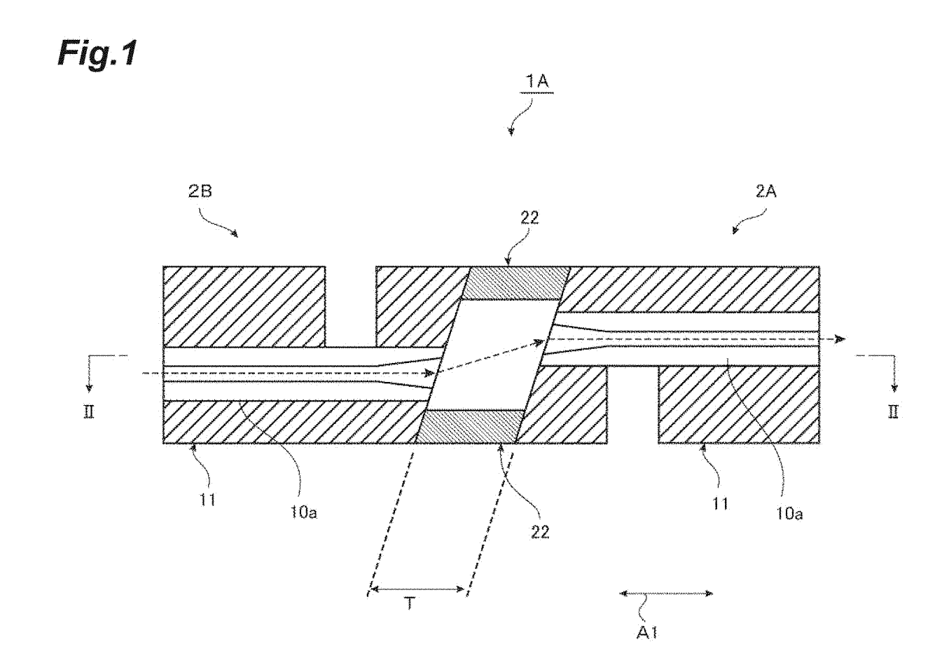

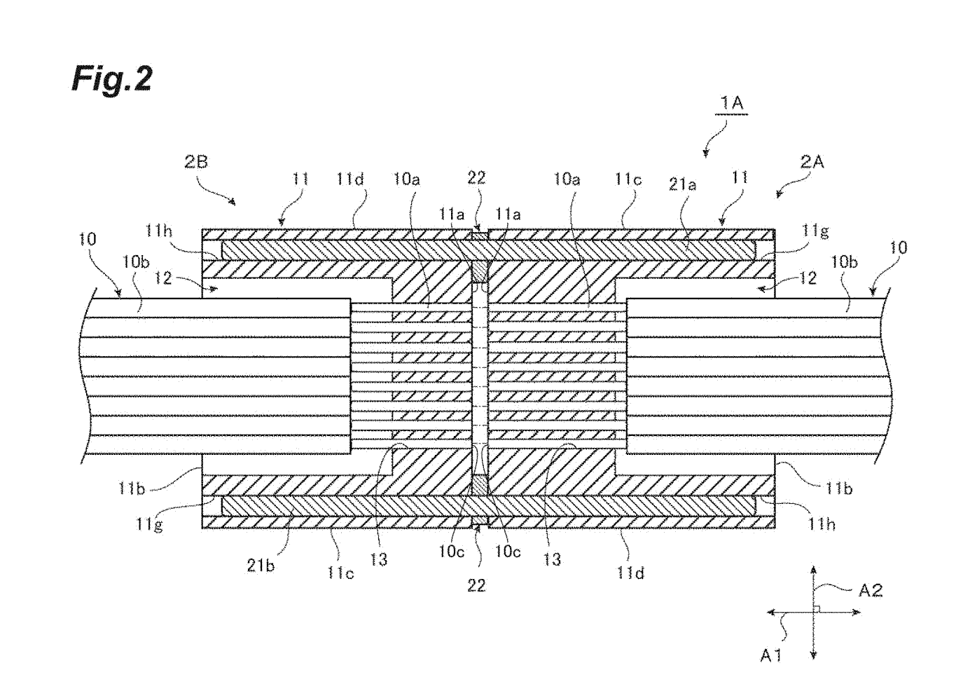

FIG. 1 is a side sectional view illustrating a configuration of an optical coupling structure 1A according to an embodiment of the present invention, and illustrates a cross section along optical axes of a pair of optical fibers 10a that are optically coupled. FIG. 2 is a sectional view of the optical coupling structure 1A taken along line II-II of FIG. 1. As illustrated in FIGS. 1 and 2, the optical coupling structure 1A of the present embodiment includes a first optical connector-equipped fiber 2A and a second optical connector-equipped fiber 2B, both of which are connected to each other. The first and second optical connector-equipped fibers 2A and 2B have the same shapes (approximately rectangular parallelepiped shapes), and face each other in a state in which one thereof is vertically inverted with respect to the other.

Each of the first and second optical connector-equipped fibers 2A and 2B includes a plurality of optical fibers 10a (eight optical fibers 10a are illustrated in FIG. 2), and a ferrule 11 that holds the optical fibers 10a. The plurality of optical fibers 10a extend in a connecting direction (along arrow A1 of the figure), and are arranged side by side in a direction (a second direction) A2 crossing a connecting direction (a first direction) A1. Each coated fiber 10 has the optical fiber 10a and a resin jacket 10b that covers the optical fiber 10a. The optical fiber 10a is exposed by removing the resin jacket 10b from a part in the connecting direction to the leading end face 10c.

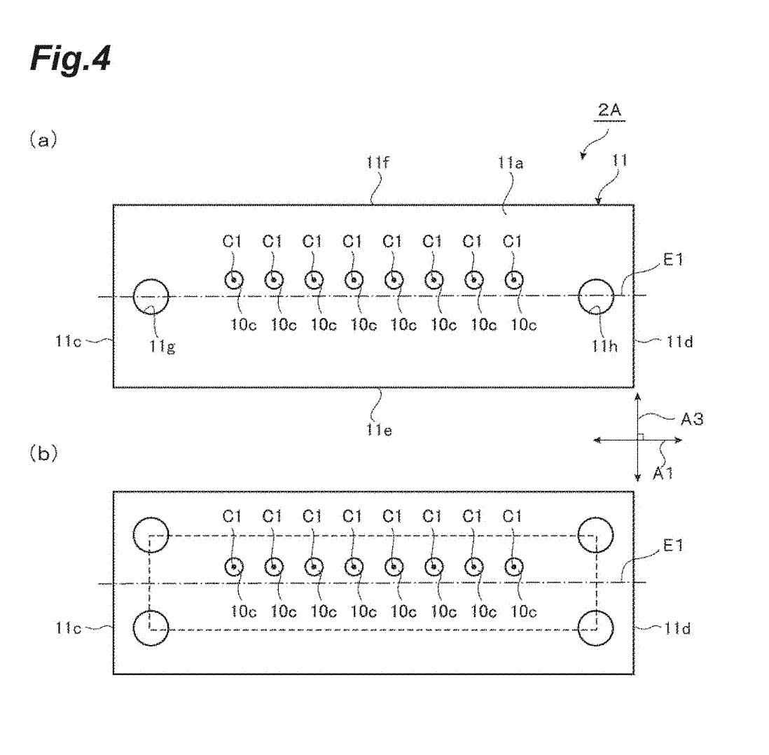

The ferrule 11 has an external appearance of an approximately rectangular parallelepiped shape, and is formed of, for instance, a resin. The ferrule 11 has an end face 11a that is provided on one end side of the connecting direction A1, and a rear end face 11b that is provided on the other end side. In addition, the ferrule 11 has a pair of lateral faces 11c and 11d that extend in the connecting direction. A1, and bottom and top faces 11e and 11f (see FIG. 4(a)). The end face 11a of the optical connector-equipped fiber 2A and the end face 11a of the optical connector-equipped fiber 2B face each other. A pair of guide holes 11g and 11h that are arranged in a direction crossing the cross section along the optical axes of the optical fibers 10a (the direction A2 in the present embodiment) are formed in these end faces 11a. Guide pins 21a and 21b (see FIG. 2) are respectively inserted into these guide holes 11g and 11h. The guide pins 21a and 21b fix a relative position between the optical connector-equipped fiber 2A and the optical connector-equipped fiber 2B.

An introduction hole 12 for receiving a plurality of coated fiber 10 as a whole is formed in the rear end face 11b. A plurality of optical fiber holding holes 13 are for rued to pass from the introduction hole 12 through to the end face 11a. The plurality of optical fibers 10a are respectively inserted into and held by these optical fiber holding holes 13. The leading end face 10e of each of the optical fibers 10a is exposed on the end face 11a and is preferably flush with the end face 11a. A gap is provided between the leading end faces 10c of the optical fibers 10a and the leading end faces 10c of the counterpart optical fibers 10a. The leading end faces 10c are optically coupled with the leading end faces 10c of the optical fibers 10a of the counterpart optical connector-equipped fiber via the gap without interposing an optical element such as a lens, a refractive index matching agent, and so on. Therefore, light emitted from the leading end face 10c of the one optical fiber is incident upon the leading end face 10c of the other optical fiber.

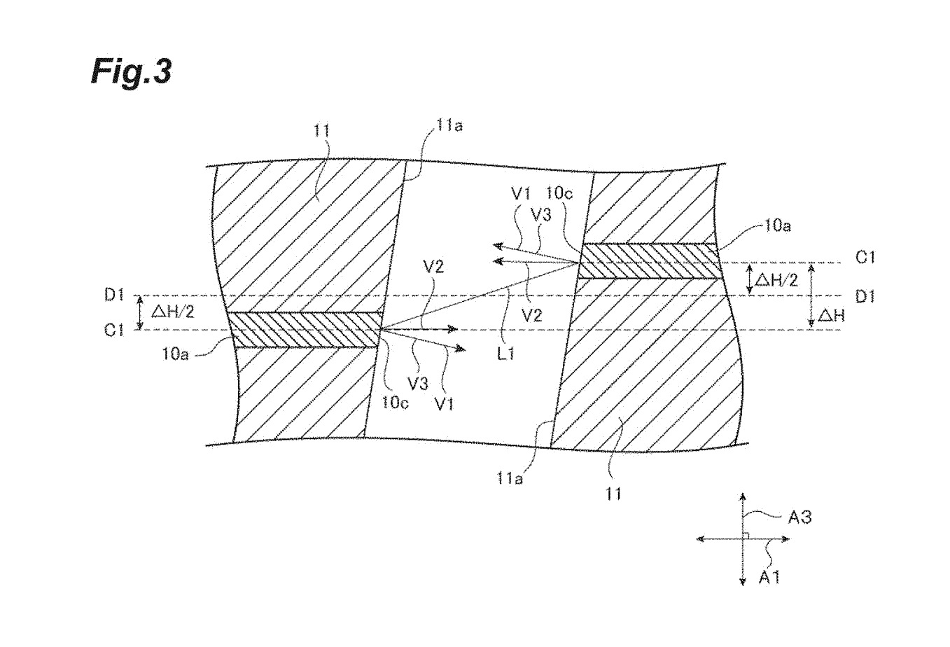

FIG. 3 is an enlarged sectional view illustrating the vicinity of the leading end face 10c of the optical fiber 10a. As illustrated in FIG. 3, in the cross section along the optical axes of the pair of optical fibers 10a that are optically coupled, normal directions V1 of the leading end face 10c and the end face 11a of the optical fiber 10a are approximately parallel to each other and are inclined with respect to directions V2 of the optical axes of the optical fibers 10a. Here, the expression “approximately parallel” refers to a parallelism formed by fixing a relative position between the fixing leading end face 10c and the end face 11a and polishing the fixing leading end face 10c and the end face 11a, and means that, for instance, an angle between a normal vector V3 of the leading end face 10c and a normal vector V1 of the end face 11a is equal to or less than 1°. Thereby, return light reflected on the leading end face 10c can be reduced. In this case, an optical path L1 of the light emitted from the leading end face 10c of the optical fiber 10a is refracted on the leading end face 10c. Since a spacer 22 (see FIG. 1) and the ferrule 11 are different members, the inclined end face 11a and the inclined leading end face 10c of the optical fiber 10a can be easily formed by polishing or the like.

As illustrated in FIG. 3, the normal vector V1 of the end face 11a on at least a region that intersects a central axis C1 of the optical fiber holding hole 13 is inclined in a direction A3 with respect to the central axis C1 of the optical fiber holding hole 13. This inclination angle has a preferred range of, for instance, 8° or less. The end faces 11a of the optical connector-equipped fibers 2A and 2B are inclined by the same angle in directions opposite to each other in a state in which the optical connector-equipped fibers 2A and 2B are vertically inverted and face each other, and are approximately parallel to each other. Here, the expression “approximately parallel” refers to a parallelism formed by uniformity of a thickness T of the spacer 22, and means that, for instance, an angle between the normal vector V1 of the end face 11a of the optical connector-equipped fiber 2A and the normal vector V1 of the end face 11a of the optical connector-equipped fiber 2B is equal to or more than 179° and equal to or less than 180°. Further, the central axis C1 of the optical fiber holding hole 13 of the optical connector-equipped fiber 2A and the central axis C1 of the optical fiber holding hole 13 of the optical connector-equipped fiber 2B are each shifted in the direction A3. This shift amount ΔH is decided by a refractive index of a core of the optical fiber 10a, an inclination angle of the end face 11a, and a distance between both of the end faces 11a, and is 4 μm for instance when the refractive index of the core is 1.50, the inclination angle of the end face is 8°, and the distance between the end faces is 60 μm.

As described above, the optical connector-equipped fibers 2A and 2B have the same shapes as each other, are configured such that a relative position therebetween in the leftward/rightward direction A2 as well as a relative position therebetween in the upward/downward direction A3 is fixed by the guide pins 21a and 21b (see FIG. 2), and face each other in the state in which one thereof is vertically inverted with respect to the other. The optical fiber holding holes 13 of the optical connector-equipped fibers 2A and 2B are located at positions at which the central axes C1 thereof are shifted by ΔH/2 from a guide hole central axis D1 therebetween.

The same content as the foregoing will be represented in another aspect of the optical connector. FIG. 4(a) is a front view illustrating the end face 11a. As illustrated in FIG. 4(a), central positions C1 of the leading end faces 10c of the optical fibers 10a on the end face 11a are shifted slightly upward with respect to a straight line E1 connecting the centers of the two guide holes 11g and 11h. In other words, the central axes of the optical fibers 10a are shifted by ΔH/2 toward the top face 11f side with respect to the center of the ferrule 11 in the direction A3 (the third direction, that is the upward/downward direction of the ferrule 11) that intersects both of the directions A1 and A2. Therefore, even when the optical paths L1 are refracted, the optical fibers 10a can be adequately optically coupled because the optical connector-equipped fibers 2A and 2B are vertically inverted and connected to each other, and thereby the optical axes of the optical fibers 10a are shifted away from one another in the upward/downward direction.

Similarly, FIG. 4(b) is an example in which the number of guide holes is more than two, and shows a front view of the end face 11a having four guide holes. When a relative position between two optical connectors that are optically coupled by inserting guide pins into four guide holes is more accurately fixed, if the central positions C1 of the leading end faces 10c of the optical fibers 10a are shifted by ΔH/2 toward the top face 11f side with respect to the straight line E1 (that is, the straight line E1 which passes through the center of a region surrounded by all of the guide holes and in which a plane parallel to the top face 11f and the bottom face 11e can intersect the end face 11a) parallel to a straight line that passes through midpoints between centers of upper and lower guide holes and connects centers of left and right guide holes, the optical fibers 10a can be more adequately optically coupled. As in the present embodiment, the relative position between two optical connectors is more accurately fixed using the more guide pins, and thereby the optical fibers 10a of the optical connector-equipped fibers 2A and 2B having configurations that are identical to each other can be more adequately optically coupled.

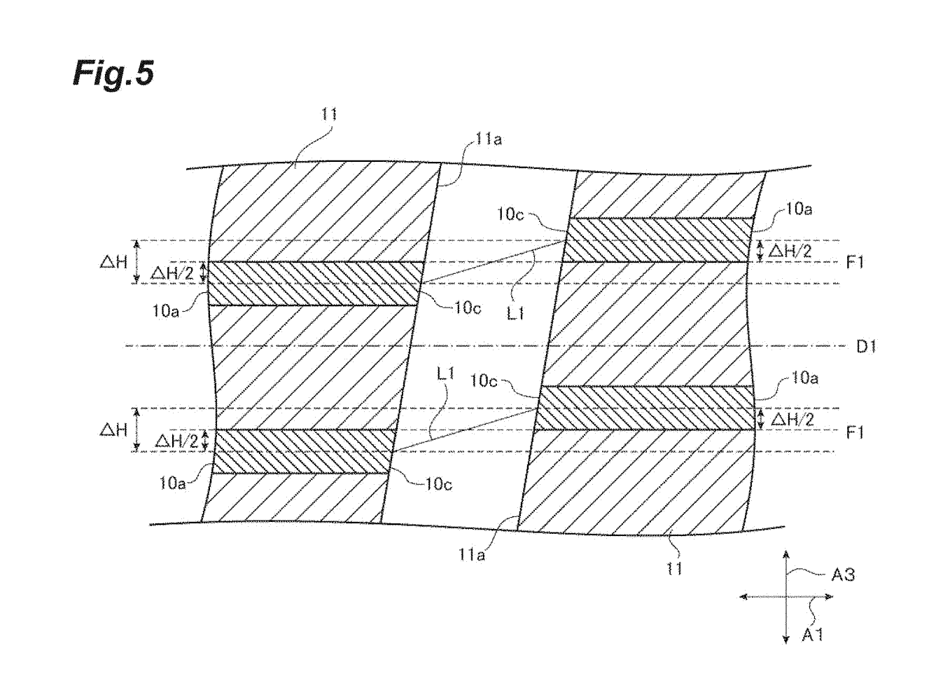

FIG. 5 is an enlarged side sectional view illustrating the vicinities of the leading end faces 10c of the optical fibers 10a of the optical coupling structure 1A according to the embodiment of the present invention, and shows a cross section along optical axes of a pair of the optical fibers 10a that are optically coupled. In the cross section along the optical axes of the pair of optical fibers 10a that are optically coupled, the optical fiber holding holes 13 of each stage in the upward/downward direction A3 are located at positions at which the central axes C1 thereof are shifted by ΔH/2 from a position F1 at which the guide hole central axis D1 therebetween is linearly symmetrical as an axis of symmetry. Thereby, the optical fibers 10a can be adequately optically coupled in the upward/downward direction A3 even when in two or more stages. As in the present embodiment, the central positions C1 of the leading end faces 10c of the optical fibers 10a are arranged in two or more stages in the direction A3. Thereby, even in the case of an ultra-multifiber in which the number of optical fibers 10a of the optical connector-equipped fibers 2A and 2B exceeds 24, the optical fibers 10a of the optical connector-equipped fibers 2A and 2B can be adequately optically coupled.

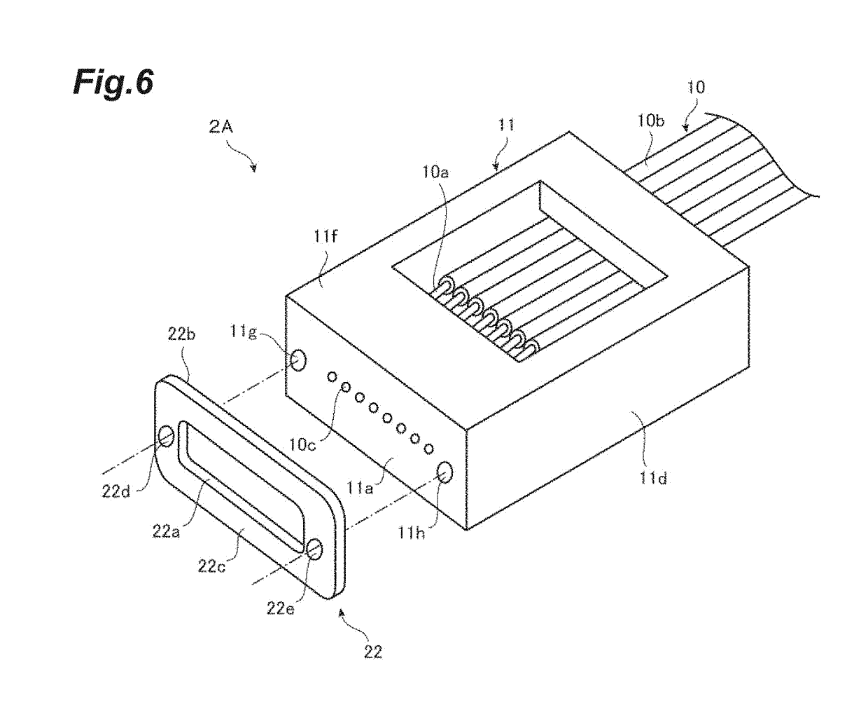

The optical connector-equipped fiber 2A further includes the spacer 22. FIG. 6 is an exploded perspective view of the spacer 22 and the optical connector-equipped fiber 2A. The spacer 22 is provided on the end face 11a, and regulates a space between the end face 11a and the end face 11a of the optical connector-equipped fiber 2B. Specifically, the spacer 22 has a plate shape with an opening 22a, and is configured such that one face 22b thereof contacts then adheres the end face 11a of the optical connector-equipped fiber 2A and the other face 22c contacts the end face 11a of the optical connector-equipped fiber 2B when connected to the optical connector-equipped fiber 2B. The opening 22a allows passage of a plurality of optical paths L1 extending between the leading end faces 10c of the plurality of optical fibers 10a of the optical connector-equipped fiber 2A and the leading end faces 10c of the plurality of optical fibers 10a of the optical connector-equipped fiber 2B. The thickness T (see FIG. 1) of the spacer 22 in the connecting direction A1 is, for instance, equal to or more than 20 μm and equal to or less than 100 μm, and preferably equal to or more than 55 μm and equal to or less than 65 μm. In this way, the spacer 22 is thin so that light emitted from the leading end faces 10c of the optical fibers 10a can reach the leading end faces 10c of the optical fibers 10a of the counterpart optical connector (the optical connector-equipped fiber 2B) before a diameter of the beam of light expands, and hence a drop in optical coupling efficiency can be suppressed. A material of which the spacer 22 is formed may be the same material as the ferrule. The spacer may be one component or a plurality of components.

Thereby, a predetermined space can be easily provided between the end face 11a and a counterpart optical connector (or between the end faces 11a of the first and second optical connector-equipped fibers 2A and 2B). Therefore, a noncontact optical coupling structure can be realized to reduce close adhesion of foreign materials so that cleaning of the end face 11a (for instance, by blowing with an air duster) can be eased or made unnecessary. Unlike a PC system, multiple optical fibers 10a can be connected at the same time without requiring a great force for connection. Further, since a lens is not interposed between the fibers, the number of optical members present on the optical path can be reduced. This makes it possible to suppress an optical coupling loss, to facilitate an aligning process, and to reduce the number of manufacturing processes to keep a cost low.

The spacer 22 has as many through-holes as the guide pins. FIG. 6 is an example in which the number of guide pins is two. The guide pins 21a and 21b (see FIG. 2) respectively pass through through-holes 22d and 22e. Thereby, in a state in which the optical connector-equipped fibers 2A and 2B are connected to each other, the spacer 22 is stably held by the guide pins 21a and 21b.

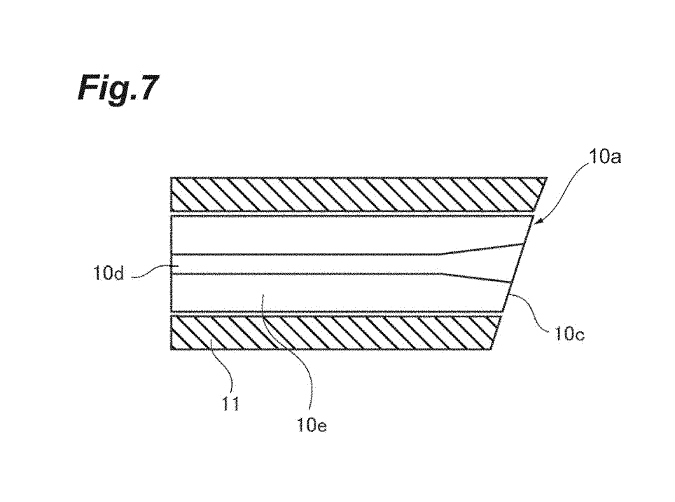

As is illustrated in a schematic view of FIG. 7, the optical fiber 10a has a core 10d and a cladding 10e. An MFD of the core 10d is gradually increased toward the leading end face 10c, and is maximized at the leading end face 10c. It is appropriate for the MFD at the leading end face 10c to be, for instance, equal to or more than 15 μm and equal to or less than 25 μm, and may be equal to or more than 10 μm and equal to or less than 30 μm. This optical fiber 10a has smaller numeral aperture than that of a typical optical fiber. Therefore, the expansion of the emitted light can be suppressed, and the optical coupling efficiency of the optical fibers can be improved even without the lens being interposed between the fibers. This optical fiber 10a is suitably realized by, for instance, a thermally-diffused expanded core (TEC) fiber.

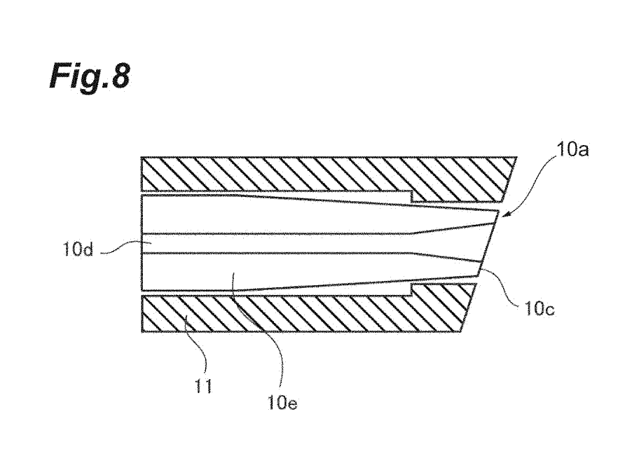

When the optical fiber is processed to create the aforementioned TEC fiber, a leading end of the optical fiber 10a may be thinned as illustrated in a schematic view of FIG. 8. A hole diameter of a ferrule end face portion of the optical fiber holding hole 13 is smaller than that of a ferrule rear portion according to an outer diameter of the leading end of the optical fiber 10a. Thereby, the core 10d of the optical fiber 10a can be accurately aligned with the center of the optical fiber holding hole 13 without performing alignment work. For example, the hole diameter of the ferrule rear portion (a first region that does not include the ferrule end face portion) is 125 μm, and the hole diameter of the ferrule end face portion (a second region including the ferrule end face portion) is 124 μm. In the aforementioned example, ΔH/2 is 2 μm, and the core 10d of the optical fiber 10a needs to be aligned with the center of the optical fiber holding hole 13 with a tolerance that is sufficiently smaller than this. As in the present embodiment, the hole diameter of the optical fiber holding hole 13 may be reduced in the vicinity of the end face 11a. Thereby, the core 10d of the optical fiber 10a can be accurately aligned with the center of the optical fiber holding hole 13 without performing alignment work.

The optical connector-equipped fiber and the optical coupling structure according to the present invention are not limited to the aforementioned embodiment, and can be modified in other various ways. For example, in the above embodiment, a gap between the end faces 11a of the ferrules 11 of the optical connector-equipped fibers 2A and 2B is filled with air, but the filler is not limited to air as long as a refractive index thereof is constant. In the above embodiment, the present invention is applied to a multifiber ferrule, but it may also be applied to a single-fiber ferrule.

### REFERENCE SIGNS LIST

1A Optical coupling structure
2A, 2B Optical connector
10 Coated fiber
10a Optical fiber
10b Resin jacket
10c Leading end face
10d Core
10e Cladding
11 Ferrule
11a End face
11b Rear end face
11c, 11d Lateral face
11e Bottom face
11f Top face
11g, 11h Guide hole
12 Introduction hole
13 Optical fiber holding hole
21a, 21b Guide pin
22 Spacer
A1 Connecting direction
C1 Central axis
D1 Guide hole central axis
E1 Straight line
L1 Light
V1 Normal vector
V2 Optical axis direction
V3 Normal vector

1. An optical connector-equipped fiber comprising
optical fibers and a ferrule,
wherein the ferrule includes optical fiber holding holes that hold the optical fibers, a ferrule end face that faces a counterpart optical connector, and guide holes into which guide pins are inserted,
leading end faces of the optical fibers are exposed on the ferrule end face,
normal directions of the ferrule end face and the leading end faces of the optical fibers are approximately parallel and are inclined with respect to directions of optical axes of the optical fibers,
a spacer is provided as another member on the ferrule end face,
the spacer has an opening allowing passage of optical paths that extend from the leading end faces of the optical fibers, and
MFDs of the optical fibers are gradually expanded toward the leading end faces and are maximized at the leading end faces.

2. The optical connector-equipped fiber according to claim 1, wherein:
outer diameters of the optical fibers are gradually reduced toward the leading end faces;
each of the optical fiber holding holes includes a first region that does not include the ferrule end face portion and a second region that includes the ferrule end face portion; and
a diameter of the second region of the optical fiber holding hole is smaller than that of the first region of the optical fiber holding hole.

3. The optical connector-equipped fiber according to claim 1,
wherein the MFDs are equal to or more than 10 μm and equal to or less than 30 μm at the leading end faces.

4. The optical connector-equipped fiber according to claim 1,
wherein the spacer is formed of the same material as the ferrule.

5. An optical coupling structure comprising
first and second optical connector-equipped fibers connected to each other,
wherein each of the first and second optical connector-equipped fibers has optical fibers and a ferrule,
the ferrule includes optical fiber holding holes that hold the optical fibers, a ferrule end face that faces a counterpart optical connector, and guide holes into which guide pins are inserted,
leading end faces of the optical fibers are exposed on the ferrule end face,
normal directions of the ferrule end face and the leading end faces of the optical fibers are approximately parallel and are inclined with respect to directions of optical axes of the optical fibers,
MFDs of the optical fibers are gradually expanded toward the leading end faces and are maximized at the leading end faces,
the first and second optical connector-equipped fibers face each other in a vertically inverted state in which the ferrule end faces thereof are approximately parallel to each other, and a spacer is provided as another member between the ferrule end faces thereof,
the spacer has an opening allowing passage of optical paths that extend from the leading end faces of the optical fibers, and
the first and second optical connector-equipped fibers have relative positions fixed by the guide pins.

6. The optical coupling structure according to claim 5,
wherein the optical axes of the pair of facing optical fibers that are optically coupled are not present on the same optical axis.

7. The optical coupling structure according to claim 5, wherein the spacer is formed of the same material as the ferrule.
